(19) United States
(12) Patent Application Publication
(10) Pub. No.: US 2007/0236503 A1
(43) Pub. Date: Oct. 11, 2007

(54) DIGITAL VISUAL INTERFACE APPARATUS

(75) Inventors: Nan-Jiun Yin, Hsinchu (TW); Yen-Hsien Su, Hsinchu (TW)

Correspondence Address: J C PATENTS, INC., 4 VENTURE, SUITE 250, IRVINE, CA, 92618, US

(73) Assignee: Coretronic Corporation, Hsinchu (TW)

(21) Appl. No.: 11/468,562

(22) Filed: Aug. 30, 2006

(30) Foreign Application Priority Data
Apr. 7, 2006 (TW) 95112372

(51) Int. Cl. G06F 13/14

(52) U.S. Cl. 345/520

(57) ABSTRACT

A digital visual interface apparatus includes a digital visual interface, a first memory, a second memory, and a switch unit. A transmission mode of the digital visual interface apparatus includes a digital mode and an analog mode. The first memory and the second memory are respectively used for storing the extended display identification data (EDID) in the digital mode and the analog mode. Wherein, the switch unit provides an operating voltage to the first memory when the transmission mode of the digital visual interface apparatus is in the digital mode, and the switch unit provides an operating voltage to the second memory when the transmission mode of the digital visual interface apparatus is in the analog mode.

### CROSS-REFERENCE TO RELATED APPLICATION

This application claims the priority benefit of Taiwan application serial no. 95112372, filed on Apr. 7, 2006. All disclosure of the Taiwan application is incorporated herein by reference.

### BACKGROUND OF THE INVENTION

1. Field of the Invention

The present invention relates to a digital visual interface (DVI). More particularly, the present invention relates to a digital visual interface apparatus which switches between reading/writing extended display identification data (EDID) in digital mode and analog mode.

2. Description of Related Art

A video source apparatus usually obtains display information and setting values of a video display apparatus through extended display identification data (EDID). Usually, a conventional digital visual interface can read/write only one type of EDID because the conventional digital visual interface supports only one type of read-only memory using for storing EDID in the digital mode or the analog mode.

As requirements of users for a higher quality video and more convenient and extendable for the display apparatus, the digital visual interface supporting only one signal mode can not meet all the requirements and is not ideal in extendibility.

### SUMMARY OF THE INVENTION

Accordingly, the present invention is to provide a digital visual interface apparatus having two memories so that the digital visual interface apparatus can respectively read/write the extended display identification data (EDID) in a digital mode and an analog mode.

According to another aspect of the present invention, a digital visual interface apparatus is provided which selectively provides an operating voltage to the memories so that the digital visual interface apparatus can respectively read/write the EDID in a digital mode and an analog mode.

To achieve the aforementioned and other objectives, the present invention provides a digital visual interface apparatus. A transmission mode thereof includes a digital mode and an analog mode. The digital visual interface apparatus includes a digital visual interface (DVI), a first memory, a second memory, and a switch unit. The memories are respectively coupled to the DVI, and the switch unit is coupled to power supply terminals of the two memories. Wherein, the switch unit provides an operating voltage to the first memory when the transmission mode of the digital visual interface apparatus is in the digital mode, and the switch unit provides an operating voltage to the second memory when the transmission mode of the digital visual interface apparatus is in the analog mode.

According to an embodiment of the present invention, the switch unit includes a microprocessor, a resistor, an inverter, and a buffer. Wherein a first terminal of the resistor is coupled to a control pin of the DVI, a second terminal of the resistor is coupled to the microprocessor, an input terminal of the inverter is coupled to the first terminal of the resistor, and an output terminal of the inverter is coupled to the power supply terminal of the first memory. The input terminal of the buffer is coupled to the first terminal of the resistor, and the output terminal of the buffer is coupled to the power supply terminal of the second memory.

According to another embodiment of the present invention, the switch unit includes an inverter and a buffer. An output terminal of the inverter is coupled to the power supply terminal of the first memory, and an input terminal of the inverter is coupled to a control pin of the DVI. An output terminal of the buffer is coupled to the power supply terminal of the second memory, and an input terminal of the buffer is coupled to the control pin of the DVI.

Wherein the control pin outputs a control signal. The inverter provides a first operating voltage to the first memory according to the control signal when the transmission mode of the digital visual interface apparatus is in the digital mode, and the buffer provides a second operating voltage to the second memory according to the control signal when the transmission mode of the digital visual interface apparatus is in the analog mode.

The memories are respectively used for storing extended display identification data (EDID) in the digital mode and the analog mode. The operating voltage is selectively supplied to one of the memories so as to switch between reading/writing EDID in the digital mode and the analog mode. Thus, the present invention can be applied to the DVI in both the digital mode and the analog mode and can provide more convenient and more extendable image transmission.

In order to make the aforementioned and other objects, features and advantages of the present invention comprehensible, a preferred embodiment accompanied with figures is described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a circuit diagram of a digital visual interface apparatus according to an embodiment of the present invention.

FIG. 1B is a circuit diagram of a digital visual interface apparatus according to another embodiment of the present invention.

FIG. 2A is a circuit diagram of a digital visual interface apparatus according to still another embodiment of the present invention.

FIG. 2B is a circuit diagram of a digital visual interface apparatus according to yet another embodiment of the present invention.

FIG. 3 is a circuit diagram of a digital visual interface apparatus according to yet another embodiment of the present invention.

FIG. 4 is a circuit diagram of a digital visual interface apparatus according to yet another embodiment of the present invention.

### DESCRIPTION OF EMBODIMENTS

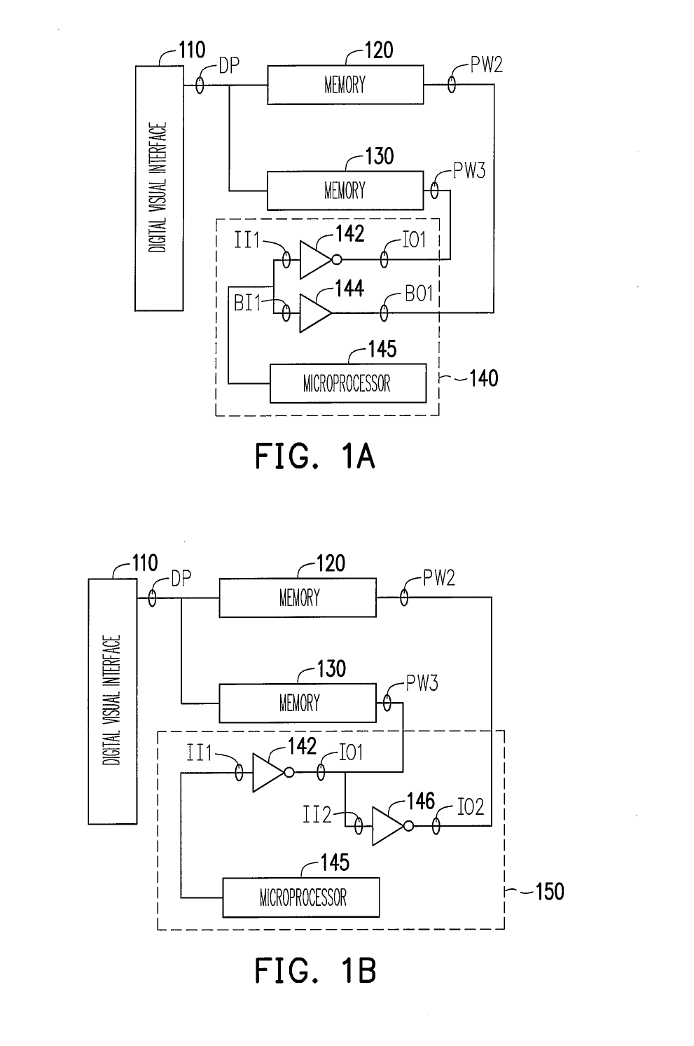

FIG. 1A is a circuit diagram of a digital visual interface apparatus according to an embodiment of the present invention. Referring to FIG. 1A, the digital visual interface apparatus includes a digital visual interface (DVI) 110, a switch unit 140, and memories 120 and 130, wherein the switch unit 140 includes a microprocessor 145, an inverter 142, and a buffer 144. The DVI 110 is coupled to the memories 120 and 130 through a data pin DP. In the present embodiment, a transmission interface between the DVI 110 and the memories 120, 130 complies with the transmission protocol of inter-integrated circuit (I²C) bus. An input terminal II1 of the inverter 142 is coupled to the microprocessor 145, an output terminal IO1 of the inverter 142 is coupled to a power supply terminal PW3 of the memory 130, an input terminal BI1 of the buffer 144 is coupled to the microprocessor 145, and an output terminal BO1 of the buffer 144 is coupled to a power supply terminal PW2 of the memory 120.

The memories 120 and 130 are respectively used for storing extended display identification data (EDID) in a digital mode and an analog mode. In the present embodiment, the memory 120 is used for storing the EDID in the analog mode, and the memory 130 is used for storing the EDID in the digital mode.

The signals output by the microprocessor 145 can be set to a logic high voltage or a logic low voltage according to requirements of users. When the digital visual interface apparatus is in the analog mode, the microprocessor 145 outputs a signal with a logic high voltage to the input terminal II1 of the inverter 142 and the input terminal BI1 of the buffer 144, and then the inverter 142 outputs a signal with a logic low voltage. Thus, an operating voltage received by the memory 130 is zero so that the memory 130 is in a stop status. The buffer 144 outputs a signal with the logic high voltage to the power supply terminal PW2 of the memory 120 according to the logic high voltage output from the microprocessor 145 so as to provide a required operating voltage to the memory 120. For example, the DVI 110 can read/write the EDID in analog mode from/to the memory 120 through the data pin DP.

Contrarily, when the digital visual interface apparatus is in the digital mode, the microprocessor 145 outputs the signal with the logic low voltage to the input terminal II1 of the inverter 142 and the input terminal BI1 of the buffer 144, and then the buffer 144 outputs a signal with the logic low voltage to the power supply terminal PW2 of the memory 120. Thus, an operating voltage received by the memory 120 is zero so that the memory 120 is in the stop status. The inverter 142 outputs a signal with logic high voltage to the power supply terminal PW3 of the memory 130 according to the signal with the logic low voltage output by the microprocessor 145 so as to provide a required operating voltage to the memory 130. For example, the DVI 110 can read/write the EDID in digital mode from/to the memory 130 through the data pin DP. As described above, the microprocessor 145 selectively provides a signal with the operating voltage to one of the memories 120 and 130, so as to switch a transmission mode of the digital visual interface apparatus in the digital mode or the analog mode by controlling a logic voltage level of the output signal.

In another embodiment of the present invention, the memory 130 is used for storing the EDID in the analog mode, and the memory 120 is used for storing the EDID in the digital mode. The circuit operation thereof is well known to those having ordinary skill in the art through the present disclosure without being described herein.

FIG. 1B is a circuit diagram of a digital visual interface apparatus according to another embodiment of the present invention. A main difference between FIG. 1B and FIG. 1A is the difference between the switch units 150 and 140. Referring to FIG. 1B, the switch unit 150 includes a microprocessor 145 and inverters 142 and 146. An input terminal II1 of the inverter 142 is coupled to the microprocessor 145, and an output terminal IO1 of the inverter 142 is coupled to a power supply terminal PW3 of the memory 130. An input terminal II2 of the inverter 146 is coupled to an output terminal IO1 of the inverter 142, and an output terminal IO2 of the inverter 146 is coupled to a power supply terminal PW2 of the memory 120.

When the microprocessor 145 outputs a signal with a logic high voltage to the input terminal II1 of the inverter 142, the inverter 142 outputs a signal with a logic low voltage to the power supply terminal PW3 of the memory 130. Thus, an operating voltage received by the memory 130 is zero so that the memory 130 is in the stop status. Because the inverter 142 outputs the signal with the logic low voltage, the inverter 146 outputs a signal with a logic high voltage to the power supply terminal PW2 of the memory 120 so as to provide a required operating voltage to the memory 120.

Contrarily, when the microprocessor 145 outputs a signal with a logic low voltage, the inverter 140 outputs a signal with a logic high voltage to the power supply PW3 of the memory 130, so as to provide a required operating voltage to the memory 130. Thus, the digital visual interface apparatus selectively provides a signal with the operating voltage to one of the memories 120 and 130 by the microprocessor 145, so as to switch a transmission mode of the digital visual interface apparatus in the digital mode or the analog mode. The other circuit operation details in FIG. 1B are similar to those in FIG. 1A and should be understood by those with ordinary skill in the art, without being described here again.

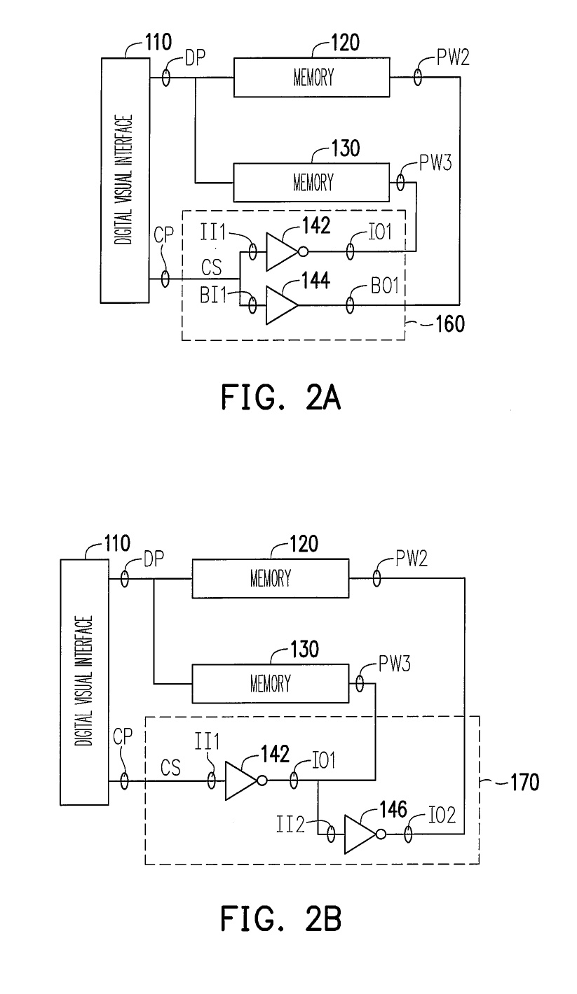

FIG. 2A is a circuit diagram of a digital visual interface apparatus according to still another embodiment of the present invention. A switch unit 160 in the FIG. 2A is different from the switch unit 140 in the FIG. 1A. Referring to FIG. 2A, the switch unit 160 includes an inverter 142 and a buffer 144. An input terminal II1 of the inverter 142 and an input terminal BI1 of the buffer 144 are respectively coupled to a control pin CP of the DVI 110. An output terminal IO1 of the inverter 142 is coupled to a power supply terminal PW3 of the memory 130, and an output terminal BO1 of the buffer 144 is coupled to a power supply terminal PW2 of the memory 120. The DVI 110 outputs a control signal CS through the control pin CP, so as to selectively provide an operating voltage to one of the memories 120 and 130. When the digital visual interface apparatus is in analog mode, the DVI 110 outputs the control signal CS with a logic high voltage to the input terminal II1 of the inverter 142 and the input terminal BI1 of the buffer 144. Thus, the buffer 144 outputs a signal with a logic high voltage to the power supply terminal PW2 of the memory 120 so as to provide a required operating voltage to the memory 120.

Contrarily, the control signal CS has the logic low voltage when the digital visual interface apparatus is in the digital mode, so that the memory 130 receives the required operating voltage through the output signal outputted from the inverter 142. For example, the DVI 110 can read/write the EDID in the digital mode from/to the memory 130 through the data pin DP. As described above, the DVI 110 selectively provides an operating voltage to one of the memories 120 and 130, so as to switch a transmission mode of the digital visual interface apparatus in the digital mode or the analog mode by adjusting the logic voltage level of the control signal CS.

In FIG. 2A, a user or an external apparatus can directly switch the operating status of the memories 120 and 130 through the control pin CP of the DVI 110. Thus, when the digital visual interface apparatus writes for example, the EDID to the memories 120 and 130 through the external apparatus, the external apparatus directly switches the memories 120 and 130 by controlling the pin CP. Accordingly, the communication between the external apparatus and the digital visual interface apparatus is made more convenient and extendable.

FIG. 2B is a circuit diagram of a digital visual interface apparatus according to yet another embodiment of the present invention. A main difference between the embodiments in FIG. 2B and FIG. 2A is that circuit structures of a switch unit 170 and a switch unit 160 are not the same. The switch unit 170 controls an operating status of memories 120 and 130 through inverters 142 and 146. An input terminal II1 of the inverter 142 is coupled to a control pin CP, and an output terminal IO1 thereof is coupled to a power supply terminal PW3 of the memory 130. An input terminal II2 of the inverter 146 is coupled to an output terminal IO1 of the inverter 142, and an output terminal IO2 of the inverter 146 is coupled to a power supply terminal PW2 of the memory 120.

When the digital visual interface apparatus is in the analog mode, the DVI 110 outputs a control signal CS with a logic high voltage to the input terminal II1 of the inverter 142. Thus, the inverter 146 outputs a signal with a logic high voltage to the power supply terminal PW2 of the memory 120 so as to provide the required operating voltage to the memory 120.

Contrarily, the control signal CS has a logic low voltage when the digital visual interface apparatus is in the digital mode, so that the memory 130 receives a required operating voltage through the output signal outputted from the inverter 142. For example, the DVI 110 can read/write the EDID in digital mode from/to the memory 130 through the data pin DP. As described above, the DVI 110 selectively provides an operating voltage to one of the memories 120 and 130, so as to switch the transmission mode of the digital visual interface apparatus in the digital mode or the analog mode by adjusting the logic voltage level of the control signal CS.

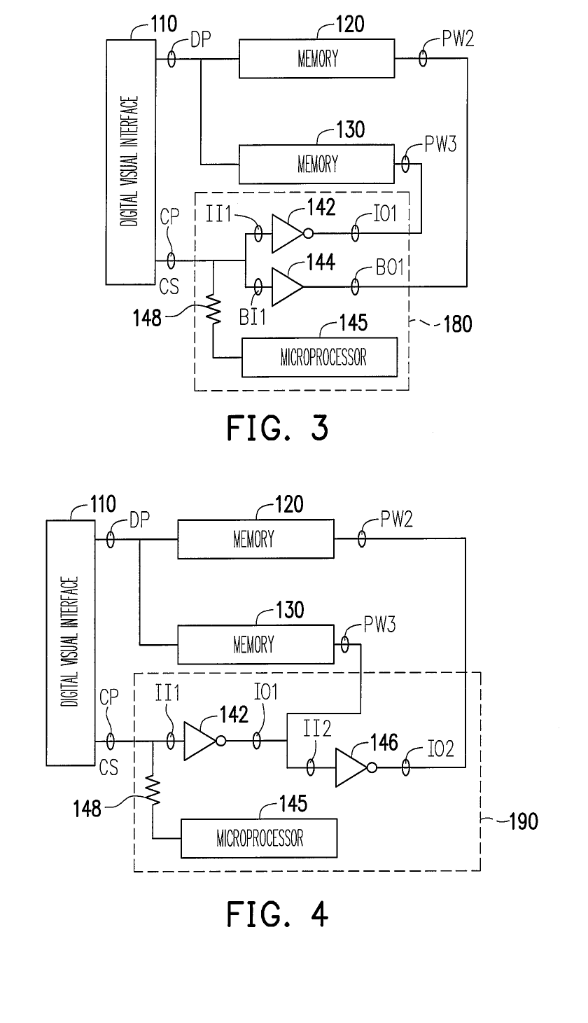

FIG. 3 is a circuit diagram of a digital visual interface apparatus according to yet another embodiment of the present invention. Referring to the FIG. 3, the digital visual interface apparatus includes a DVI 110, memories 120, 130, and a switch unit 180. Wherein, the switch unit 180 further includes a microprocessor 145, a resistor 148, an inverter 142, and a buffer 144.

The DVI 110 is coupled to the memories 120 and 130 through a data pin DP, and the switch unit 180 is coupled between power supply terminals PW2 of the memories 120 and PW3 of the 130. The DVI 110 selectively provides an operating voltage to one of the memories 120 and 130. A main difference of the circuits in FIG. 3 and FIG. 1A is in the resistor 148 and the microprocessor 145 of the switch unit 180. The resistor 148 is coupled between the microprocessor 145 and a control pin CP. An output voltage level of the inverter 142 is controlled by an output signal outputted from the DVI 110. An output voltage level of the buffer 144 is controlled by an output signal outputted from the microprocessor 145. Operating voltages of the memories 120 and 130 are respectively provided by the output voltage levels of the buffer 144 and the inverter 142. Thus, the digital visual interface apparatus in the present embodiment is controlled in two manners, namely a hardware control manner and a software control manner.

The hardware control manner refers to that switching for the operating voltages of the memories 120 and 130 is mainly controlled by the control pin CP of the DVI 110 when the output signal from the microprocessor 145 has the logic low voltage. The memory 120 receives a required operating voltage through an output signal from the buffer 144 when the control signal CS output from the DVI 110 has a logic high voltage. Here, a transmission mode of the digital visual interface apparatus is in the analog mode (i.e. to provide a function of reading/writing the EDID in the analog mode). If the control signal CS has a logic high voltage, the memory 130 receives the required operating voltage through the inverter 142. Here, the transmission mode of the digital visual interface apparatus is in the digital mode (i.e. to provide a function of writing/reading the EDID in the digital mode).

The software control manner refers to that switching for the operating voltages of the memories 120 and 130 is controlled by the microprocessor 145. The voltage level of the output signal outputted from the microprocessor 145 can be directly set by the software. However, the circuit structure of the present invention is not limited to the present embodiment. In the software control manner, the control pin CP does not output the control signal CS, such as the control pin CP in floating mode, and switching the operating voltages of the memories 120 and 130 is mainly controlled by the microprocessor 145.

If the output signal outputted from the microprocessor 145 has a logic high voltage, the memory 120 receives the required operating voltage through the buffer 144. Here, the operation mode of the digital visual interface apparatus is in the analog mode (i.e. to provide the function of reading/writing the EDID in analog mode). If the output signal outputted from the microprocessor 145 has a logic low voltage, the memory 130 receives the required operating voltage through the inverter 142. Here, the transmission mode of the digital visual interface apparatus is in the digital mode (i.e. to provide a function of reading/writing the EDID in the digital mode). The other operation details of the present embodiment are well known to those having ordinary skill in the art without being described herein.

FIG. 4 is a circuit diagram of a digital visual interface apparatus according to yet another embodiment of the present invention. A main difference between FIG. 4 and FIG. 3 is the difference in a switch unit 190 and a switch unit 180. Referring to FIG. 4, an output terminal of the inverter 146 is coupled to a power supply terminal of the inverter 142 and the memory 120. The other operation details of the circuit in FIG. 4 are similar to FIG. 3, which are not repeated hereinafter.

In FIGS. 1˜4, the DVI 110 includes a DVI connector, and the memories 120 and 130 are electrically erasable programmable read only memories (EEPROM).

According to the present invention, two memories are disposed in the digital visual interface apparatus for storing the EDID in the digital mode and the analog mode respectively, and the operating status of the memories is switched through the voltage level. Thus, the digital visual interface apparatus has a dual support function, and switching for the operating status of the two memories is controlled by a signal pin so that the circuit design cost is greatly reduced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A digital visual interface apparatus, a transmission mode of the digital visual interface apparatus comprising a digital mode and an analog mode, the digital visual interface apparatus comprising:
a digital visual interface, having a data pin;
a first memory, coupled to the data pin of the digital visual interface;
a second memory, coupled to the data pin of the digital visual interface; and
a switch unit, respectively coupled to a power supply terminal of the first memory and a power supply terminal of the second memory;
wherein, the switch unit provides a first operating voltage to the first memory when the transmission mode of the digital visual interface apparatus is in the digital mode, the switch unit provides a second operating voltage to the second memory when the transmission mode of the digital visual interface apparatus is in the analog mode, and the digital visual interface apparatus reads/writes extended display identification data from/to one of the first memory and the second memory through the data pin.

2. The digital visual interface apparatus as claimed in claim 1, wherein when the transmission mode of the digital visual interface apparatus is in the digital mode, the digital visual interface apparatus reads/writes the extended display identification data from/to the first memory, and the extended display identification data is an interface data of the digital visual interface apparatus in the digital mode.

3. The digital visual interface apparatus as claimed in claim 1, wherein when the transmission mode of the digital visual interface apparatus is in the analog mode, the digital visual interface apparatus reads/writes the extended display identification data from/to the second memory, and the extended display identification data is an interface data of the digital visual interface apparatus in the analog mode.

4. The digital visual interface apparatus as claimed in claim 1, wherein the digital visual interface is a digital visual interface connector.

5. The digital visual interface apparatus as claimed in claim 1, wherein the switch unit comprises:
a microprocessor;
a resistor, having a first terminal coupled to a control pin of the digital visual interface and a second terminal coupled to the microprocessor;
an inverter, having an input terminal coupled to the first terminal of the resistor and an output terminal coupled to the power supply terminal of the first memory; and
a buffer, having an input terminal coupled to the first terminal of the resistor and an output terminal coupled to the power supply terminal of the second memory.

6. The digital visual interface apparatus as claimed in claim 1, wherein the switch unit comprises:
a microprocessor;
a resistor, having a first terminal coupled to a control pin of the digital visual interface and a second terminal coupled to the microprocessor;
a first inverter, having an input terminal coupled to the first terminal of the resistor and an output terminal coupled to the power supply terminal of the first memory; and
a second inverter, having an input terminal coupled to the output terminal of the first inverter and an output terminal coupled to the power supply terminal of the second memory.

7. The digital visual interface apparatus as claimed in claim 1, wherein the switch unit comprises:
a microprocessor;
an inverter, having an input terminal coupled to the microprocessor and an output terminal coupled to the power supply terminal of the first memory; and
a buffer, having an input terminal coupled to the microprocessor and an output terminal coupled to the power supply terminal of the second memory.

8. The digital visual interface apparatus as claimed in claim 1, wherein the switch unit comprises:
a microprocessor;
a first inverter, having an input terminal coupled to the microprocessor and an output terminal coupled to the power supply terminal of the first memory; and
a second inverter, having an input terminal coupled to the output terminal of the first inverter and an output terminal coupled to the power supply terminal of the second memory.

9. The digital visual interface apparatus as claimed in claim 1, wherein the switch unit comprises:
an inverter, having an output terminal coupled to the power supply terminal of the first memory and an input terminal coupled to a control pin of the digital visual interface; and
a buffer, having an output terminal coupled to the power supply terminal of the second memory and an input terminal coupled to the control pin of the digital visual interface;
wherein, the control pin outputs a control signal, the inverter provides a first operating voltage to the first memory according to the control signal when the transmission mode of the digital visual interface apparatus is in the digital mode, the buffer provides a second operating voltage to the second memory according to the control signal when the transmission mode of the digital visual interface apparatus is in the analog mode.

10. The digital visual interface apparatus as claimed in claim 1, wherein the switch unit comprises:
a first inverter, having an output terminal coupled to the power supply terminal of the first memory and an input terminal coupled to a control pin of the digital visual interface; and
a second inverter, having an output terminal coupled to the power supply terminal of the second memory and an input terminal coupled to the output terminal of the first inverter;
wherein, the control pin outputs a control signal, the first inverter provides a first operating voltage to the first memory according to the control signal when the transmission mode of the digital visual interface apparatus is in the digital mode, the second inverter provides a second operating voltage to the second memory according to the control signal when the transmission mode of the digital visual interface apparatus is in the analog mode.

11. The digital visual interface apparatus as claimed in claim 1, wherein the first memory and the second memory comprise electrically erasable programmable read only memories (EEPROM).
